(19) United States
(12) Patent Application Publication
(10) Pub. No.: US 2016/0038363 A1
(43) Pub. Date: Feb. 11, 2016

(54) Disposable Triage Cubical Assembly

(71) Applicants: Mitchell ALTMAN, (US); Scott SHARITZ, (US)

(72) Inventor: Scott Sharitz, Round Rock, TX (US)

(21) Appl. No.: 14/782,055

(22) PCT Filed: Apr. 2, 2014
(86) PCT No.: PCT/US2014/032694

§ 371 Date: Oct. 2, 2015

Related U.S. Application Data
(60) Provisional application No. 61/807,606, filed on Apr. 2, 2013.

(51) Int. Cl. A61G 10/00; A61G 7/002

(52) U.S. Cl. CPC A61G 10/005; A61G 7/002

(57) ABSTRACT

A triage cubicle assembly comprises an enclosure of foldable material sufficiently large to accommodate a disaster victim and at least one other person when deployed, the enclosure being releasably attachable to an external overhead frame for support, and having a floor configured to have a portion overlie a victim-supporting surface higher than the floor and external to the enclosure. In the preferred embodiment, the external overhead canopy frame is collapsible, and the victim-supporting surface is a table-like structure that fits within a notch formed in the bottom exterior of the envelope. The frame and table are preferably collapsible to require minimum storage space when not deployed. If the victim is deceased, the enclosure can be undipped or otherwise released from the frame, and folded into a body bag containing all of the victim's information and belongings and medical waste.

### PRIORITY CLAIM

This application claims priority of U.S. Provisional Patent Application 61/807,606 filed Apr. 2, 2013, the content of which is hereby incorporated by reference.

### FIELD OF THE INVENTION

The present invention relates to an instant disaster triage cubical that, in its preferred embodiment, is paper-based and disposable.

As used herein the term “disaster” includes major incidents. The World Health Organization defines a disaster as an event of such a magnitude that the normal conditions of existence are so badly disrupted and the subsequent level of suffering is of such a nature that the community is unable to respond to it. A major incident is a situation which places significant demand on the medical resources regarding the number, severity, or type of live casualties so as to warrant the response of extraordinary resources.

Triage is one of the tools at the forefront of dealing with a large influx of casualties arising from a disaster, and refers to the process of sorting the injured according to a priority that establishes an order for treatment and evacuation. The sorting process must identify the dead, those who are so severely injured that they will not survive, or whose treatment will tie up resources that would be best used to treat those needing the most urgent intervention, and those who can wait longer for treatment.

For those who can be treated, priorities are also established for the order in which the injured are to be treated, and the order in which they are to be moved by emergency teams from the incident site to hospitals and other medical care centers.

### SUMMARY

The invention herein is a disposable, instant disaster triage cubical that instantly turns into a medical waste and body bag post mortem, or can be instantly cleaned and/or disposed of and replaced in order to accommodate the next casualty. Because storage space is at a premium, the triage cubicle has a compact storage profile and configuration that enables communities and emergency responders to maximize the number of units that can be stored in a given space.

The triage cubical comprises an enclosure of foldable material sized to enclose an interior region sufficiently large to accommodate a disaster victim and at least one other person when deployed, the enclosure being releasably attachable to an exterior overhead frame for support, and having a floor configured to overlie a raised victim-supporting surface external to the enclosure. In its preferred embodiment, a triage cubical assembly utilizes an exterior reusable folding (or otherwise disassemblable) frame to support a compactly foldable enclosure formed, for example, from plastic, a weather-resistant paper, a fiber material, a cloth or a clothlike material. Preferably, the enclosure is formed from Tyvek® (a trademark of E. I. Du Pont de Nemours and Company Corporation of Wilmington, Del., US for sheets of man-made fibers) or a Tyvek®-type material.

The cubicle provides privacy and temporary shelter for the victim, shields the public from the sometimes-horrific injuries sustained by the victims, can include one or more pockets in it that hold medical disposables (e.g., smocks, gloves, masks, shoe coverings, syringes, disposable digital camera, DNA swabs etc.), medical waste (the used—smocks, gloves, etc), and the victim's clothes, belongings and ID.

If the victim is deceased, the enclosure can be unclipped or otherwise released from the frame, and folded into a body bag containing all of the victim's information and belongings and medical waste.

Other elements that can be included in the triage cubical, and folded into a body bag if necessary, are air sanitizer/decadents, and a treatment pack (e.g., gloves, booties, smocks, eye protection).

The triage cubical can also include a special Velcro® pocket on the exterior that is preferably also accessible from the exterior if the cubical is folded into a body bag that can hold pictures of the victim, DNA swabs and any other items on the body that can assist with identification . . . all without having to expose the body again. Naturally, any releasably-securable pocket or pocket-covering flap can be used as well so secure the contents of the pocket until access is desired.

As described below, the preferred embodiment of the triage cubical provides the following benefits:

(1) A quickly deployable configuration comprising two main parts:
a reusable folding frame w/gurney stand, and
disposable room inserts akin to a big paper box having a floor, ceiling and walls;
(2) A triage cubicle that has a number of benefits, such as:
containing contamination to a single patient;
ensuring a clean environment for every patient;
containing all medical waste within the bounds of a conveniently disposable cubicle;
allowing quicker identification of casualties post-disaster without having to expose the body again;
minimizing the risk of misidentifying bodies;
minimizing the spread of disease from dysentery and bio exposure;
allowing bodies to be stored for days in an open environment;
quick deployment;
minimal space requirements when not used so that hundreds can be on site at numerous disaster centers within a city such as school gyms and other space-limited venues at minimal cost;
privacy for the dead, preventing children and other victims from viewing the bodies, thereby reducing post-disaster behavioral health treatment, and ensuring the highest level of “in field” postmortem respect for the deceased;
privacy for the non-fatally and potentially fatally injured; and
inexpensive.

Greater details concerning the invention are provided below in the description of the preferred embodiment of a triage cubical constructed in accordance with the invention, of which the accompanying drawings form a part. Neither the description of the preferred embodiment nor the accompanying drawings are to be construed to limit the invention. Rather, the scope of this invention is intended to be limited only by the prior art. As will be appreciated, the Figures herein depict the preferred embodiment of the triage cubicle and its components in schematic form for the sake of clarity, and are not necessarily to scale. In addition, all dimensions provided are by way of example only, and are approximate.

### BRIEF DESCRIPTION OF THE DRAWINGS

FIG. 1 is a right rear oblique view in schematic of a deployed triage cubicle assembly constructed in accordance with the invention;

FIG. 2 is a right front oblique view of a currently preferred gurney and canopy frame structure constructed in accordance with the invention in its deployed configuration;

FIG. 3 is an oblique top plan view in schematic illustrating a tarp for supporting a person on the gurney in accordance with a preferred embodiment of the invention;

FIG. 4a is a front elevation view in schematic of the currently preferred gurney in its storage configuration;

FIG. 4b is a front elevation view in schematic of the currently preferred canopy frame in its storage configurations;

FIG. 4c is a front elevation view in schematic of an alternative storage configuration for a canopy frame and gurney constructed in accordance with the invention; and

FIG. 5 is a front elevation view in schematic of the deployed triage cubicle assembly of FIG. 1.

### DETAILED DESCRIPTION OF THE PREFERRED EMBODIMENT

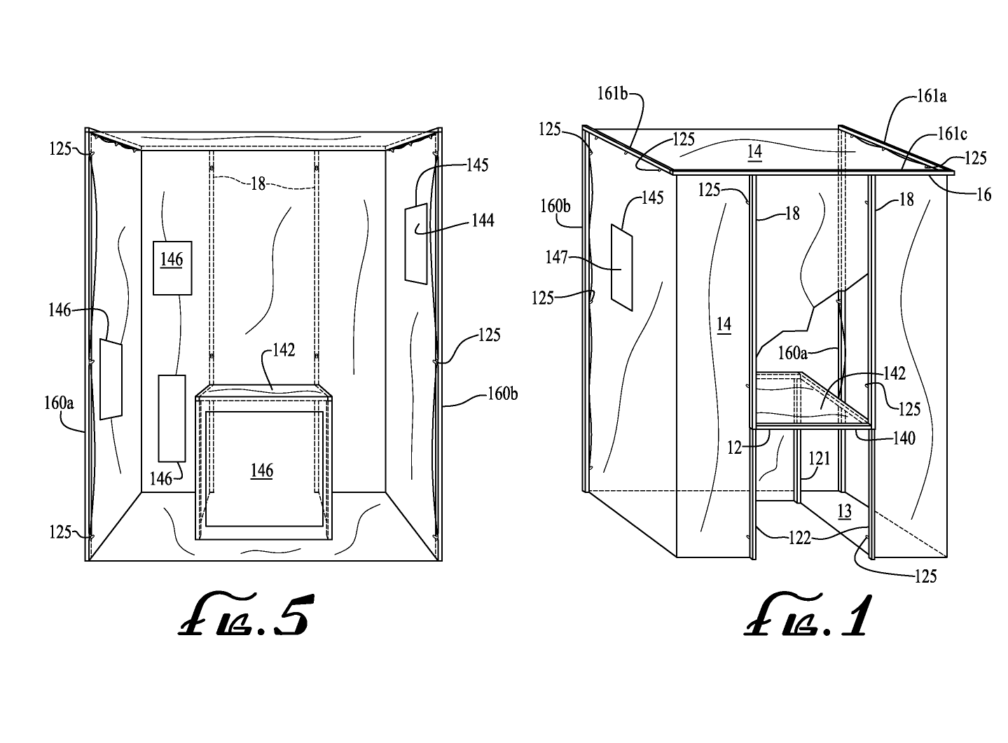

FIG. 1 is a right rear oblique view in schematic of a deployed triage cubicle assembly constructed in accordance with the invention. A victim-supporting surface carrier in the form of a gurney 12 is disposed within a bottom slot 13 of a triage enclosure 14 that, in turn, is supported by a canopy frame 16 comprising a plurality of overhead frame members 161a, 161b, 161c. The canopy frame 16 is supported by a pair of uprights 18 extending from the gurney, as well by vertical canopy frame members 160a, 160b (FIG. 5) that are in contact with the floor or ground generally opposite the uprights at the front of the deployed cubicle.

Referring to FIG. 2, an oblique front right view of a preferred gurney and canopy frame structure in the deployed configuration is schematically illustrated as comprising a gurney having a rectangular top frame 120 supported by two front legs 121 and two rear legs 122. Each of the legs 121, 122 respectively extends from a bottom end 121a, 122a to a top end 121b, 122b. All four legs are attached to the top frame 120 of the gurney by hinge members that permit the legs to be folded upward into a position parallel, and closely adjacent to, the top frame 120 and preferably to the longer sides thereof. In the deployed configuration, the gurney's rear legs 122 extend upward past the top frame 120 to form the uprights 18 that support the canopy frame 16 as described with respect to FIG. 1.

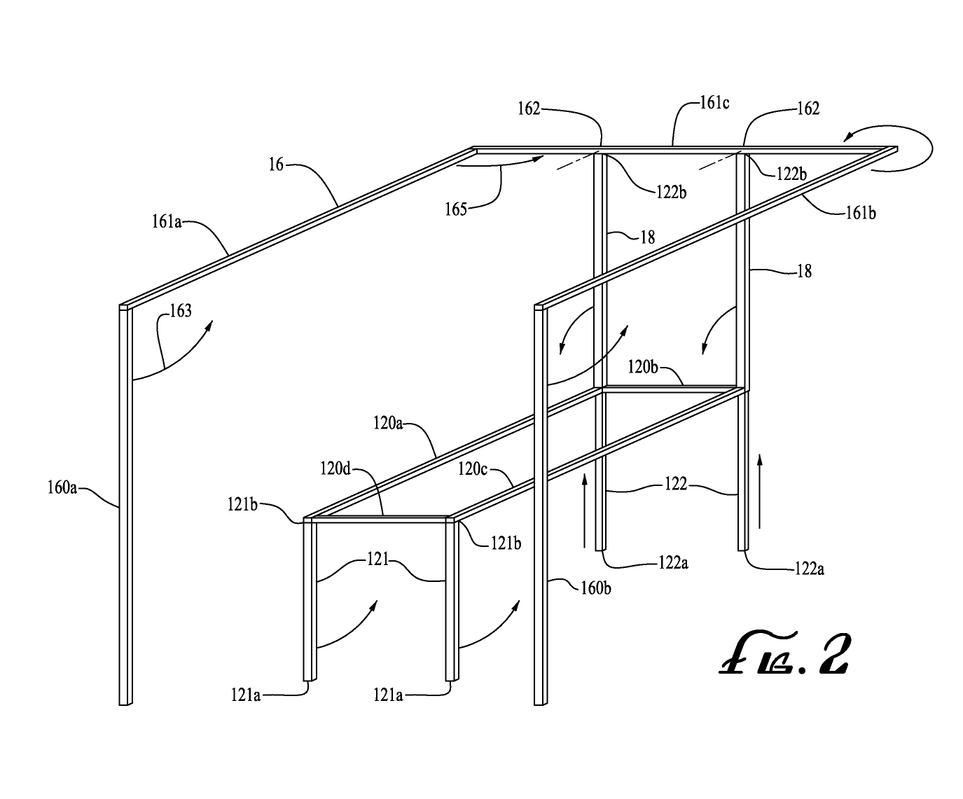

A preferably foldable tarp 123 (FIG. 3) is supported by the top frame 120 of the gurney to support a victim. The tarp 123 is preferably formed from a light-weight, foldable plastic material such as the type from which commonly available tarps are made, and can be strengthened by nylon strips 124 such as are used to form automobile seatbelts. Loops or eyelets 125 are provided for hooking over accommodating kooks on the top frame of the gurney so that the tarp can be quickly removed and replaced, but alternative victim-supporting surfaces—either replaceable or not—can be used without departing from the scope of the invention.

As used herein, the term “gurney” is used to denote a structure having generally flat victim-supporting surface that is supported above the floor (or ground). While the preferred gurney utilizes four legs to support the victim-supporting surface, it will be appreciated that the invention herein is not limited to any specific support structure for the victim-supporting surface.

Returning to FIG. 2, the canopy frame 16 comprises two front vertical frame members 160a, 160b, which provide floor (or ground) support to the rest of the canopy frame, and which are hinged to respective top frame members 161a, 161b which extend above and generally parallel to the gurney. The frame members 161a, 161b are, in turn, coupled by hinges, pins or the like to opposing ends of a rear transversly-extending frame member 161c, that extends above and generally transverse to the gurney. The transverse frame member 161c locks into the uprights 18 at regions 162 so that the canopy frame is supported by the uprights as well as the two front vertical frame members 160a, 160b.

When the preferred gurney is being stored, transported or otherwise non-deployed, the front legs 121 of the gurney can be folded up towards and against its top frame 120 to which they are coupled via a hinge arrangement, pin arrangement, swivel arrangement or other known means for permitting the folding movement. The top portion of the rear legs 122 (which form the uprights) are folded down towards and against the top frame 120. The bottom portion of each rear legs is configured to telescope into or over the relative upper portion of the leg so that the total length of the folded and telescoped leg is minimized for easier transport and storage of the gurney. Numerous telescoping configurations are known with reversibly locking mechanisms that secure the two segments in their extended configurations for deployment: e.g., cantilevered buttons aligned with holes, as typically used for beach umbrellas, and protrusions which fit into L-shaped channels or slots whereby a slight twist locks the pieces in place. These and other reversibly locking mechanisms can be utilized without departing from the scope of the invention.

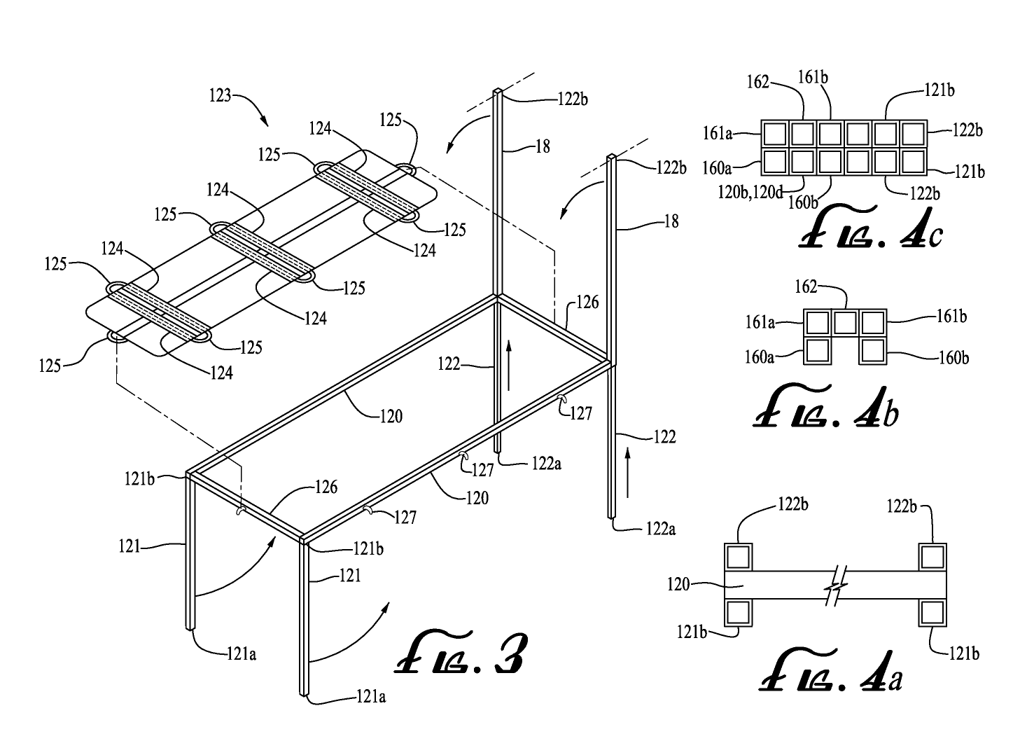

Turning briefly to FIG. 4a, a front elevation view illustrates the resulting compact configuration that is achieved for storing and/or transporting the preferred gurney. The top frame 120 of the gurney is sandwiched between the bottom legs 121 and the rear legs 122. The configuration can be made more compact, if one wishes to do so, by providing a telescoping or hinge arrangement to the each of the two lateral arms of the gurney frame 120 120d, 120e and thereby decrease the space between the left and right halves of the illustrated configuration by narrowing the width of the gurney for storage purposes.

The preferred canopy frame 16 is also configured for compact storage. When being stored, transported or otherwise non-deployed, its front vertical frame member 160a is folded upward towards and against frame member 161a (as illustrated by arrow 163), and those two frame members 160a, 161a are rotated towards and against one side of rear transverse frame member 161c (as illustrated by arrow 165). The other front vertical frame member 160b is folded upward towards and against frame member 161b, and the two frame members 160b, 161b are rotated towards and against the other side of transverse frame member 161c. Consequently, the canopy frame is in a very compact configuration. To enhance the compact storage configuration of the canopy frame 16, one or more the frame members 160a, 160b, 161a, 161b, 161c can each be formed from a telescoping pair of segments which are reversibly expanded when the canopy frame is to be deployed, thus reducing the length and width of the resulting configuration to be stored and/or transported.

FIG. 4b is a front elevation view of the resulting compact configuration that is achieved for storing and/or transporting the preferred canopy frame. The rear transverse frame member 161c is sandwiched between the two frame members 161a, 161b, and the two front vertical frame members 160a, 160b abut frame members 161a, 161b respectively.

Alternatively, rotation of the frame members in other directions can be permitted to achieve an abutting relationship. To permit rotation, the frame members can be coupled together by respective hinge arrangements which preferably lock the members in place upon deployment and are unlocked when deconstruction of the assembly is required. Alternatively, but perhaps less conveniently, the frame members can be separate elements that are reversibly coupled together by fasteners, by cantilevered buttons aligned with holes (as with beach umbrellas), by threaded engagement or any other suitable means. Those of ordinary skill in the art will recognize that any hinge or hinge arrangement described herein can be replaced with a pin arrangement, swivel arrangement or other known means for permitting the folding and/or rotating movement without departing from the scope of the invention. It will also be recognized that the elements of the preferred gurney and the preferred canopy frame that are described as being linked for folding and/or rotational movement can be releasably secured to each other by, for example, cantilevered buttons aligned with holes, as typically used for beach umbrellas, or by protrusions which fit into L-shaped channels or slots whereby a slight twist locks the pieces in place. These and other reversibly securing mechanisms can be utilized without departing from the scope of the invention.

FIG. 5 is a front elevation view of the deployed triage cubicle assembly illustrated in FIG. 1. In practice, a closeable entrance flap would block the interior view and afford privacy to the victim; the flap has not been illustrated for the sake of clarity. Once the gurney and canopy frame have been deployed, the enclosure 14 is unrolled or otherwise deployed about the canopy frame. The enclosure material is preferably a disposable paper or thin plastic product that can be stored compactly and easily deployed. Currently, DuPont's Tyvek® material appears to be preferred; it is a high-density polyethylene fiber material that is sufficiently strong, difficult to tear but easily cut with scissors or a knife, and permits water vapor can pass through, but not liquid water.

The enclosure is preferably secured to the canopy frame members by hooking eyelets 125 formed in the tent material over hooks associated with the canopy frame members in order to permit rapid deployment of the triage cubicle, as well as rapid removal and replacement of the tent material, by a single individual if necessary. Other means such as ties, Velcro straps, clips, and other reversibly securing devices used in camping or other applications can be used without departing from the scope of the invention, but are currently believed to be less advantageous.

As best shown in FIG. 1, the bottom surface of the enclosure includes an elongated notch 13 sized to accommodate the gurney. As illustrated in FIGS. 1 and 5, the “floor” of the enclosure is thereby deployed over a gurney positioned in the notch. The result is that the bottom surface of the enclosure becomes a cover for the gurney, as identified by the numeral “142” in FIG. 1. Consequently, a victim never touches the gurney, and (as described later) the replacement of the cubicle inherently replaces the surface on which the next victim is placed as individuals and bodies are moved from the triage site. At the same time, biological waste, bacteria, blood and other material is removed as the old cubical is unhooked or otherwise untethered from the canopy frame and folded into a disposable package or body bag, as the case may be.

In accordance with the invention, pockets 146 may be formed on one or more interior walls and surfaces of the cubical to hold masks, treatment/forensic kits, gloves, shoe coverings and the like for the use of attending EMS providers and coroners. Pockets may be affixed to the interior surfaces with tape, adhesive, Velcro, etc. either when the enclosure is initially folded by the manufacturer, or after deployment in anticipation of an arriving victim.

In addition, one or more of the cubicle's walls can be provided with one or more window-like openings 145 that provide accessibility to the victim's identification and/or personal belongings from the exterior of the cubical. Thus, for example, the victim's driver's license or other identification can be placed in a transparent envelope 144 in such a way as to be viewable through such an opening, and an exterior flap 147 (FIG. 1) may be provided to cover the identification except with respect to those authorized or intending to view it. The flap 147 can be stabilized in a closed position using snaps, a zipper, Velcro or other desired fasteners.

The victim's personal effects (watch, cell phone, keys, etc.) can also be placed in an envelope or pocket that can be obtained through such an opening. Accordingly, one or more such openings can be provided and, if desired, appropriately labeled for proper access from the cubicle's exterior. Thus, persons need not enter a cubicle in order to identify a victim (or find his/her location) or transfer the victim's personal effects to a family member.

Lastly, the enclosure may removed from the canopy frame and be folded in such a way as to form a body bag, with the victim's id and/or personal effects remaining accessible from the bag's exterior. This permits efficient transportation of bodies, and the ability to track the location of deceased individuals in a respectful and relatively sterile manner during a time when responders are overwhelmed, materials and resources are in short supply, and time is of the essence.

Referring briefly to FIG. 1, it may be noted that a large pocket 146 is preferable placed on a vertical “wall” of the cubicle's floor formed by the underlying gurney that supports the victim on surface 142. This pocket is intended to hold the victims clothing and other items that are to be made available to authorized personal, family members, etc. The interior of the pocket 146 is accessible from the interior of the cubicle, and also from the other side (i.e., the “backside”) of the “wall” on which it is placed. For example, the backside of the wall can be provided with zippered access to the pocket, taped access, Velcro′d access, or any other releasable closured access. If the victim is dead, the enclosure is detached from the canopy frame and folded around the victim to function as a body bag. The wall bearing the large pocket is folded over the victim's body in such a way . . . typically as the last or nearly the last step . . . that backside of the wall is on the exterior of the body bag, and the pocket can be accessed to get the victim's clothing and other stored possessions.

The preferred triage assembly yields a compactly storable assembly that can be deployed by one person if necessary, at a time when human and material resources are overwhelmed and/or scarce, and provides an efficient unit for triage of the fatally and non-fatally injured. By way of example only, and noting that all dimensions provided in this specification are approximate, a fully deployed triage cubicle assembly having a 7 ft.×7 ft.×7 ft. (2.13×2.13×2.13 meters) deployed enclosure could comprise one or more of the following:

Canopy Frame

Referring to FIG. 2, frame members 160a,b and frame members 161a,b,c are 7 ft. (2.13 meters) in length. If each of these frame members comprises three telescoping segments, the length of the telescopingly compressed frame member is reduced to 28 inches (71.12 cm) for storage purposes. If each comprises 2 telescoping segments, the length is reduced to 42 inches (1.07 meters).

Gurney

A preferred gurney is 28 inches (71.12 cm) wide and 6 ft. (1.83 meters) in length. Referring to FIG. 2, lateral frame members 120b,d are therefore 28 inches (71.12 cm) long, and are preferably removable to enable the longitudinal frame members 120a,c of the gurney to abut each other. The lateral frame members 120b,d are each preferably formed as two telescoping segments that are accordingly telescopingly reduced to 14 inches (0.36 meters) in their storage configuration.

The longitudinal frame members 120a,c of the gurney are 6 ft. (1.83 meters) in length, but can each be formed from two or three telescoping segments, reducing the length of the member for storage purposes to 3 ft. (0.91 meters) and 2 ft. (0.61 meters) respectively.

Storage Configuration for Gurney and Canopy Frame

FIG. 4C illustrates a more compact configuration for storing and transporting the canopy frame and gurney is illustrated owing to the use of the aforedescribed telescoping frame segments and the detachment of lateral gurney frame members 120b,d from the longitudinal gurney frame members. Referring briefly to FIG. 4a for reference, the space may be noted between canopy frame members 160a and 160b in the stored configuration. Referring now to FIG. 4C, it can be seen that that space is filled by detached lateral gurney frame members 120b,d. Because the telescopingly-compressed canopy frame members are 42 inches (1.07 meters) long, and the telescopingly-compressed lateral gurney frame members are 14 inches (0.36 meters) in length, they fit end to end within the 42 inch (1.07 meter) length of the illustrated packed configuration, forming a 6×2 matrix of frame members approximately 42 inches (1.07 meters) long, 6 inches (15.24 cm) wide and 2 inches (5.08 cm) high. (It may be noted that frames having a 1-inch (2.54 cm) square cross-section are currently preferred, and that is the dimension assumed herein.)

When in their respective storage configurations illustrated in FIGS. 4A and 4B or FIG. 4C, the preferred gurney frame and canopy frame fit into a single bag that is approximately 6 inches×6 inches×42 inches (152 mm×152 mm×106.7 cm). The bag is preferably a water-resistant canvas-type bag with webbed straps that can be used as the victim-supporting tarp 123 (FIG. 3) for the gurney when flattened.

Enclosure

The enclosure, in its preferred undeployed form, is folded and vacuum-sealed to form an approximately 1 ft. by 1 ft.×0.3-inch (30.5 cm×30.5 cm×7.6 mm) package. Thus a stack of 20 packages would be approximately 1 ft. wide×1 ft. long×7.5 inches thick (30.5 cm×30.5 cm×19 cm).

Integrated Triage Unit Packs

An integrated triage unit pack consisting of 4 gurney frames and 4 canopy frame configured as illustrated in FIGS. 4A, 4B together with 20 packages of enclosures will measure approximately 1 ft.×1 ft.×4 ft. (30.5 cm×30.5 cm×122 cm) and can fit in an emergency vehicle to service 4 victims at a time, and 20 victims in total.

A single pallet measuring 4 ft. wide×4 ft. long×5 ft. high (1.22 meters×1.22 meters×1.52 meters) could therefore contain 8 such packs across its width, piled 8 packs high and have room for sixteen 20-piece packages of enclosures, enabling the pallet to allow treatment of 256 persons at a time, and a total of approximately 1600 persons owing in part to the 320 extra packages of enclosures.

Although a currently preferred embodiment of the present invention and its advantages have been described in detail above, it should be understood that various details, changes, substitutions and alterations will be apparent to those of ordinary skill in the art having the benefit of the foregoing specification. For example, the gurney-accommodating notch 13 can be provided near the side of the cubicle enclosure rather than in the currently preferred generally central location illustrated in the drawing. While such a configuration limits or eliminates two-sided access to the victim, it has the advantage of permitting the width of the cubical to be reduced to thereby increase the allowable number of cubicles (and simultaneously-accommodated victims) in the space available.

Frame members that are coupled for rotation with respect to each other can be coupled by hinges, pins, ball-and-socket arrangements, rotating shaft arrangements and other known means for providing such coupling. The invention is not limited to any particular coupling means.

Further, the frame members can be disassembled into separate pieces without departing from the scope of the invention, but this is believed to be less preferred since it makes deployment of the triage cubicle less convenient and less efficient. When frame members are disassembled, releasably locking shapes and/or mechanisms can be provided to prevent unintentional disassembly while being reconfigured for deployment and/or when deployed.

Likewise, the cubicle closing entrance flap can occupy a portion or all of the front face of the deployed triage cubicle. The larger the entrance opening, the easier it is to bring victims into the cubicle. It will be recognized that criticals and DOAs will be brought in from the outside on everything from stretchers to comforters, bed sheets and body bags by responders who are becoming increasingly tired, and that larger entrances are preferred over smaller ones. At the same time, the cubicle-closing flap should preferably be securable against unintentional opening; means such as zippers, ties, Velcro straps, snaps and hook/eyelet combinations, as well as all other known means for releasably closing the flap can be used without departing from the scope of the invention.

It should be further recognized that the term “cubicle” as used herein is not intended to denote that the shape of the enclosure is necessarily a cube. Although the preferred embodiment illustrated and described here is a generally cubic shape, the term “cubicle” is intended to mean a small partitioned area, and other shapes than that described and illustrated herein are within the scope of the invention, as are the shape of, and number for frame members constituting, the overhead canopy frame.

Similarly, other embodiments of the invention permit utilization of canopy frames supported by one or more generally vertically-extending poles exterior to the enclosure that, in turn, support a plurality of generally horizontally extending spoke-like frame members above the enclosure and from which the enclosure is supported. This alternative frame configuration can be formed from separable parts, or by spokes linked to each other for folding in the manner of umbrella spokes or otherwise. The spokes are linked to the pole by an arm or similar offsetting structure that permits the pole to remain exterior to the enclosure while the spokes are located above the enclosure. By this arrangement, a preferred envelope that can be collapsed around a deceased victim into a body bag is preserved, and a portion of the enclosure's floor can overly an external victim-supporting surface as in the preferred embodiment of a triage cubicle assembly, while a generally round cubicle is more easily accommodated if one prefers that shape to others.

It is intended that all such variations be within the scope and spirit of the invention, and that the invention be solely defined by appended claims that shall be given the broadest allowable interpretation consistent with the Doctrine of Equivalents.

I claim:

1. A triage cubicle assembly comprising:
an enclosure of foldable material sized to enclose an interior region sufficiently large to accommodate a disaster victim and at least one other person when deployed, the enclosure being releasably attachable to an exterior overhead frame for support, and having a floor configured to overlie a raised victim-supporting surface external to the enclosure.

2. The triage cubicle assembly of claim 1 including a notch formed by the floor of the enclosure to accommodate the insertion of the victim-supporting surface below the floor of the enclosure, the portion of the floor overlying the victim-supporting surface thereby providing a covered surface for supporting the victim.

3. The triage cubicle assembly of claim 2 wherein the victim-supporting surface is supported by a gurney.

4. The triage cubicle assembly of claim 3 wherein the gurney includes a top frame substantially circumscribing the victim-supporting surface, and a plurality of legs supporting the victim-supporting surface above the ground or a floor external to the enclosure.

5. The triage cubicle assembly of claim 4 wherein the legs of the gurney are structured to be folded up against the top frame.

6. The triage cubicle assembly of claim 5 wherein the gurney includes a pair of upright support members extending upward from the main frame, and positioned on the gurney to support the overhead frame above the enclosure when the gurney is in the notch to support the victim.

7. The triage cubicle assembly of claim 6 wherein the pair of upright support members extending upward from a respective one of the gurney's legs.

8. The triage assembly claim 7 wherein the upright support members telescope into or around the respective legs when the legs are folded against the top frame.

9. The triage assembly of claim 1 including an exterior overhead frame for supporting the enclosure.

10. The triage assembly of claim 9 wherein the exterior overhead frame includes three frame members, at least two of said frame members being coupled for rotation with respect to each other in such a way that the frame members can substantially abut each other in a storage configuration.

11. The triage assembly of claim 10 wherein two of the frame members are coupled for rotation to the third of said frame members in such a way that said two frame members substantially abut the third frame member in the storage configuration.

12. The triage assembly of claim 10 wherein at least one of the frame members is formed by telescoping segments.

13. The triage assembly of claim 2 wherein the portion of the floor overlying the victim-supporting surface is elevated with respect to at least the substantial remaining portion of the floor so that a generally vertically-extending portion of the enclosure having front and back faces is formed therebetween, said enclosure portion being positioned so that its back face is accessible when the enclosure is folded around a victim, and wherein
said enclosure portion includes a pocket accessible from both of said front and back faces to enable items to be inserted into the pocket at the front face when the enclosure is deployed and to be removed at the back face when the enclosure is folded about a victim.

14. The triage assembly of claim 1 wherein the deployed enclosure includes at least one generally vertically-extending wall having an inwardly facing storage pocket thereon.

15. A triage cubicle assembly comprising:
an enclosure of foldable material sized to enclose an interior region sufficiently large to accommodate a disaster victim and at least one other person when deployed, the enclosure being releasably attachable to an exterior overhead frame for support, and having a floor configured to include a raised region overlying a victim-supporting surface external to the enclosure;
an overhead frame releasably attached to the exterior of the enclosure;
a first pair of generally vertically-extending support members for supporting the overhead frame;
a second pair of generally vertically-extending support members for supporting the overhead frame at a position with respect to the enclosure that is generally opposite said first pair; and
a victim-supporting surface carrier underlying the enclosure's floor raised region to provide said rise, said second pair of generally vertically-extending support members being carried by the victim-supporting surface carrier.

16. A triage cubicle assembly comprising:
an enclosure of foldable material sized to enclose an interior region sufficiently large to accommodate a disaster victim and at least one other person when deployed, the enclosure being releasably attachable to an exterior overhead frame for support, and having a floor configured to have a portion overlie a victim-supporting surface higher than the floor and external to the enclosure.

17. The triage cubicle assembly of claim 16 wherein the enclosure is generally round when supported by the frame.

18. The triage cubicle assembly of claim 16 wherein the enclosure includes a plurality of walls circumscribing said interior region.

19. The triage cubical assembly of claim 16 wherein the exterior frame is collapsible.
